(19) United States
(12) Patent Application Publication
(10) Pub. No.: US 2020/0186668 A1
(43) Pub. Date: Jun. 11, 2020

(54) METHOD AND DEVICE FOR RECOMMENDING WATERMARK FOR ELECTRONIC TERMINAL

(71) Applicant: Samsung Electronics Co., Ltd., Suwon-si (KR)

(72) Inventors: Suxian ZHANG, Guangzhou (CN); Xiaochun LIU, Guangzhou (CN); Chen WANG, Guangzhou (CN); Jiayan LIANG, Guangzhou (CN)

(21) Appl. No.: 16/700,449

(22) Filed: Dec. 2, 2019

(30) Foreign Application Priority Data
Dec. 5, 2018 (CN) 201811480024.6

(51) Int. Cl. H04N 1/32; G06T 1/00

(52) U.S. Cl. CPC H04N 1/32149; G06F 3/0482; G06T 1/0021

(57) ABSTRACT

A method for recommending a watermark for an electronic terminal and an apparatus therefor are provided. The method includes acquiring a to-be-sent resource, identifying a purpose of the to-be-sent resource, and recommending, based on the identified purpose, a watermark added to the to-be-sent resource. According to the method and device, when a resource needs to be sent, a watermark added to the to-be-sent resource can be automatically recommended to a user based on a purpose of the to-be-sent resource, so that the security of user information can be conveniently secured.

### CROSS-REFERENCE TO RELATED APPLICATION(S)

This application is based on and claims priority under 35 U.S.C. § 119(a) of a Chinese patent application number 201811480024.6, filed on Dec. 5, 2018, in the Chinese Intellectual Property Office, the disclosure of which is incorporated by reference herein in its entirety.

### BACKGROUND

### 1. Field

The disclosure relates to the field of electronic terminals. More particularly, the disclosure relates to a method and device for recommending a watermark for an electronic terminal.

### 2. Description of Related Art

With the rapid development of the Internet, it is a common user behavior in people's lives to upload images to platforms or share images with others through electronic terminals. However, in fact, there are some security risks when users upload or share images through networks. For example, when a user uploads his or her identity (ID) card image to a platform for handling a service, there exists a risk that the user's ID card image may be stolen without the user's permission, which may harm the user's interests.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and device for recommending a watermark for an electronic terminal, which can solve the above problems in the prior art.

Additional aspects will be set forth in part in the description which follows and, in part, will be apparent from the description, or may be learned by practice of the presented embodiments.

In accordance with an aspect of the disclosure, a method for recommending a watermark for an electronic terminal is provided. The method includes acquiring a to-be-sent resource, identifying a purpose of the to-be-sent resource, and recommending, based on the identified purpose, a watermark to be added to the to-be-sent resource.

Optionally, at least one of: the acquiring a to-be-sent resource includes acquiring a preset type of to-be-sent resource, the identifying of the purpose of the to-be-sent resource includes identifying the purpose of the to-be-sent resource according to at least one of a sending scenario of the to-be-sent resource, information of a receiving object of the to-be-sent resource, or attribute information of the to-be-sent resource; the recommended watermark is used to define that the to-be-sent resource is only used for identified purpose; the recommended watermark is used to indicate the ownership of copyright of the to-be-sent resource; the recommended watermark is a digital signature; or the method further includes sending a resource added with the recommended watermark.

Optionally, the sending scenario includes at least one of: an issuer of an application for sending the to-be-sent resource, a service of the issuer, identification information of the application, a current display content in a user interface for sending the to-be-sent resource, or a context content not currently displayed in the user interface, the information of the receiving object includes at least one of attribute information of the object for receiving the to-be-sent resource, or a content of a historical communication record with the object; the attribute information of the to-be-sent resource includes at least one of a label of the to-be-sent resource, a remark of the to-be-sent resource, a name of the to-be-sent resource, or a content of the to-be-sent resource; or the preset type includes a privacy resource and/or a preset type of certificate image.

Optionally, the object for receiving the to-be-sent resource includes at least one a contact, a website, an official account, or a platform.

Optionally, the sending or the resource added with the recommended watermark includes sending a resource added with a watermark selected by a user from the recommended watermarks.

Optionally, at least one of: the recommending, based on the identified purpose, a watermark added to the to-be-sent resource includes: recommending a plurality of watermarks respectively used for defining different purposes of the to-be-sent resource based on a plurality of identified purposes; the method further includes acquiring and recommending a watermark added in a historical record of the added watermark in the to-be-sent resource; or the method further includes recommending a watermark added to the to-be-sent resource according to a user's habit of adding a watermark.

Optionally, the identifying of the purpose of the to-be-sent resource includes: acquiring a content of a watermark added to a resource sent by another electronic terminal for the same sending scenario and/or the same receiving object; and identifying the purpose of the to-be-sent resource based on the acquired content.

In accordance with another aspect of the disclosure, a device for recommending a watermark for an electronic terminal is provided. The device includes at least one processor including an acquisition unit, a purpose identification unit and a watermark recommendation unit. The acquisition unit is configured to acquire a to-be-sent resource, the purpose identification unit is configured to identify a purpose of the to-be-sent resource, and the watermark recommendation unit is configured to recommend, based on the identified purpose, a watermark to be added to the to-be-sent resource.

Optionally, at least one of: the acquisition unit is further configured to acquire a preset type of to-be-sent resource; the purpose identification unit is further configured to identify the purpose of the to-be-sent resource according to at least one of a sending scenario of the to-be-sent resource, information of a receiving object of the to-be-sent resource, or attribute information of the to-be-sent resource; the recommended watermark is further configured to define that the to-be-sent resource is only used for identified purpose; the recommended watermark is further configured to indicate the ownership of copyright of the to-be-sent resource, the recommended watermark includes a digital signature; or the at least one processor further includes a sending unit configured to send a resource added with the recommended watermark.

Optionally, at least one of: the sending scenario includes at least one of an issuer of an application for sending the to-be-sent resource, a service of the issuer, identification information of the application, a current display content in a user interface for sending the to-be-sent resource, or a context content not currently displayed in the user interface; the information of the receiving object includes at least one of attribute information of the object for receiving the to-be-sent resource, or a content of a historical communication record with the object; the attribute information of the to-be-sent resource includes at least one of a label of the to-be-sent resource, a remark of the to-be-sent resource, a name of the to-be-sent resource, or a content of the to-be-sent resource; or the preset type includes a privacy resource and/or a preset type of certificate image.

Optionally, the object for receiving the to-be-sent resource includes at least one of a contact, a website, an official account, or a platform.

Optionally, the sending unit is further configured to send a resource added with a watermark selected by a user from the recommended watermarks.

Optionally, wherein at least one of: the watermark recommendation unit is further configured to recommend a plurality of watermarks respectively used for defining different purposes of the to-be-sent resource based on a plurality of identified purposes; the watermark recommendation unit is further configured to acquire and recommend a watermark added in a historical record of the added watermark in the to-be-sent resource; or the watermark recommendation unit is further configured to recommend a watermark added to the to-be-sent resource according to a user's habit of adding a watermark.

Optionally, the purpose identification unit is further configured to acquire a content of a watermark added to a resource sent by another electronic terminal for the same sending scenario and/or the same receiving object, and identify the purpose of the to-be-sent resource based on the acquired content.

In accordance with another aspect of the disclosure, a computer readable storage medium storing a computer program is provided. The computer program is executed by a processor, the method for recommending a watermark for an electronic terminal as described above is implemented.

In accordance with another aspect of the disclosure, an electronic terminal is provided. The electronic terminal includes at least one processor, a memory for storing a computer program, and when the computer program is executed by the at least one processor, the method for recommending a watermark for an electronic terminal as described above is implemented.

With the method and device for recommending a watermark for an electronic terminal according to the embodiments of the disclosure, when a resource needs to be sent, a watermark added to the to-be-sent resource can be automatically recommended to a user based on a purpose of the to-be-sent resource. In addition, a resource added with the recommended watermark may also be sent, so that the security of user information can be conveniently secured.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a flowchart of a method for recommending a watermark for an electronic terminal according to an embodiment of the disclosure;

FIG. 2 illustrates an example of a mapping relationship between an application and services of its issuer according to an embodiment of the disclosure;

FIGS. 3, 4, and 5 illustrate an example of identifying a purpose of a to-be-sent resource according to various embodiments of the disclosure;

FIG. 6 illustrates an example of a recommended watermark according to an embodiment of the disclosure; and

FIG. 7 illustrates a block diagram of a device for recommending a watermark for an electronic terminal according to an embodiment of the disclosure.

Throughout the drawings, it should be noted that like reference numbers are used to depict the same or similar elements, features, and structures.

### DETAILED DESCRIPTION OF EMBODIMENTS

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

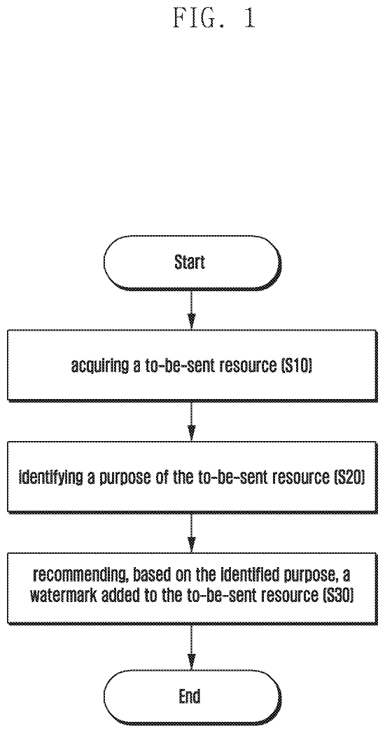

FIG. 1 illustrates a flowchart of a method for recommending a watermark for an electronic terminal according to an embodiment of the disclosure. The method may be implemented by a computer program. As an example, the electronic terminal may be a mobile communication terminal (e.g., a smart phone), a smart wearable device (e.g., a smart watch), a personal computer, a tablet computer, a game machine, a digital multimedia player, etc.

Referring to FIG. 1, in operation S10, a to-be-sent resource is acquired. As an example, the to-be-sent resource may be a video, an image, a design file, a document, etc.

As an example, the to-be-sent resource may be acquired from an album application, or acquired by calling a camera application for shooting. It should be understood that the to-be-sent resource may also be acquired by other suitable ways.

As an example, the to-be-sent resource may be acquired when a user operation for sending a resource is received. As an example, the user operation for sending a resource may be various types of user operations, for example, a user operation of uploading a resource through an application (e.g., uploading a resource to a website, a platform, an official account, etc.), or a user operation of sharing a resource to other users through an instant messaging application.

As an example, a preset type of to-be-sent resource may be acquired. In other words, when the to-be-sent resource is a resource of a preset type, subsequent operations may be executed.

As an example, the preset type may include: a privacy resource and/or a preset type of certificate image. As an example, the certificate image may be obtained by shooting or scanning a certificate. In addition, the certificate image may also include a shot image of a user holding a certificate.

As an example, the privacy resource may include at least one of the following: a certificate photo (i.e., a photo that can be used on a certificate to prove identity), a shot user video, a design file, and a document. For example, the user video may include a shot video of user holding a certificate (e.g., an identity (ID) card), a shot video of a user performing a specified action, and a shot video of a user reading a specified character. For example, the document may include a contract, an agreement, etc.

As an example, the preset type may include all of or part of certificate image types. For example, the preset type may include at least one of the following: an ID card image, a driver's license image, a driving license image, a passport image, a Hong Kong and Macao pass license image, a student ID image, a residence booklet image, a property certificate image, a contract image, a bank card image, an employee's card image, and a certificate image. For example, if the preset type includes all types of certificate images, as long as one image is a certificate image, regardless of which specific type of certificate image the image is, the image is a certificate image of the preset type. As an example, a user may set the preset type according to his/her own needs.

The type of the to-be-sent resource may be identified in various suitable ways. As an example, the type of the to-be-sent resource may be determined based on at least one of the following: a label of the to-be-sent resource, a remark of the to-be-sent resource, a name of the to-be-sent resource, and a content of the to-be-sent resource. For example, if the label of the to-be-sent image is an ID card, it may be determined that the type of the to-be-sent image is an ID card image. As an example, in response to a user's operation of labelling an image in an album application, a corresponding label may be added to the image. For example, when the image is saved in the album application, the user may be prompted to add a corresponding label to the image.

In operation S20, a purpose of the to-be-sent resource is identified.

As an example, the purpose of the to-be-sent resource may be a scenario to be used after the resource is sent to a receiver (i.e., an object for receiving the resource). For example, the scenario to be used may be a scenario for handling a service, for example, a scenario for handling a residence migration service, a scenario for handling a provident fund loan service, a scenario for handling a driver's license service, a scenario for handling a car purchase service, etc.

The purpose of the to-be-sent resource may be identified in various suitable ways. As an example, the purpose of the to-be-sent resource may be identified according to at least one of a sending scenario of the to-be-sent resource, information of a receiving object of the to-be-sent resource, and attribute information of the to-be-sent resource.

As an example, the sending scenario may include at least one of the following: an issuer of an application for sending the to-be-sent resource, a service of the issuer, identification information of the application, a current display content in a user interface for sending the to-be-sent resource, and a context content not currently displayed in the user interface.

As an example, the information of the receiving object may include at least one of the following: attribute information of the object for receiving the to-be-sent resource, and a content of a historical communication record with the object.

As an example, the attribute information of the to-be-sent resource may include at least one of the following: a label of the to-be-sent resource, a remark of the to-be-sent resource, a name of the to-be-sent resource, and a content of the to-be-sent resource.

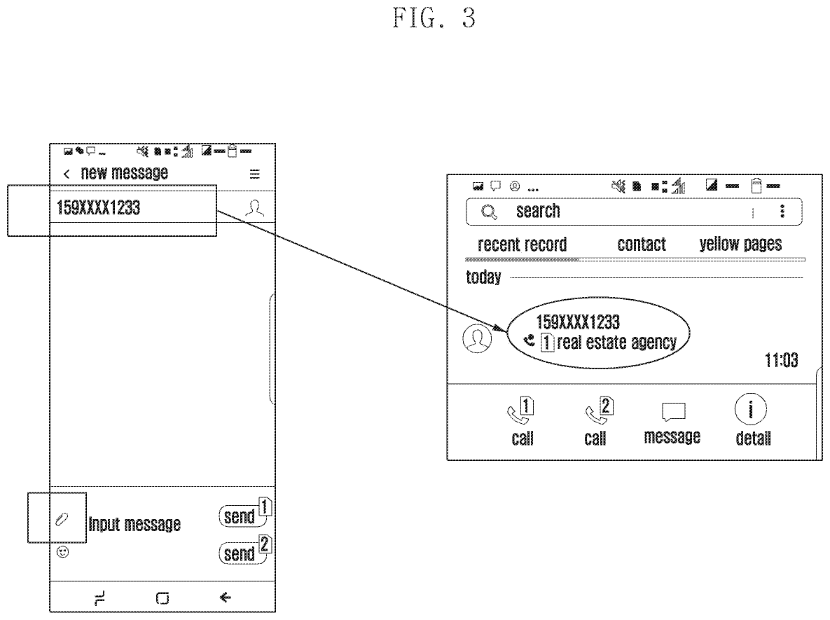

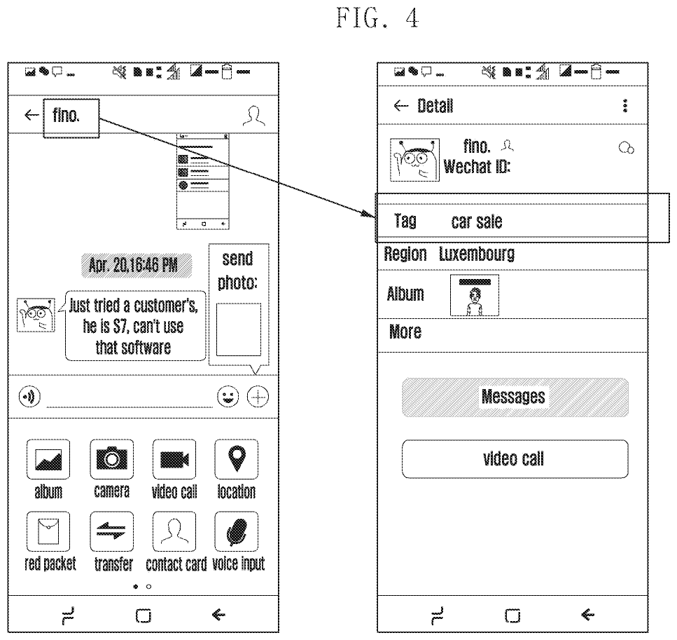

As an example, the purpose of the to-be-sent resource may be determined by the service handled by an issuer of an application for sending the to-be-sent resource. As an example, identification information (e.g., name, package name, etc.) of the application for sending the to-be-sent resource may be acquired first, and then the service of the issuer of the application is determined based on the acquired identification information. As an example, when an image is sent through an application, an album application needs to be enabled to select the to-be-sent image therein (for example, as shown in FIGS. 3 and 4, an album application is enabled in response to a user's operation of clicking a control for adding an image). In this case, a package name of the application for sending the image may be acquired by acquiring a package name of an application for enabling the album application, or, acquired based on application stack information, for example, identification information of a previous application of the album application among the applications running in the background may be acquired based on application stack information. As an example, a database may be pre-established, in which the identification information of each application may be associatively stored with its issuer, and each issuer may be associatively stored with its services; or the identification information of each application may be directly associatively stored with services of its issuer.

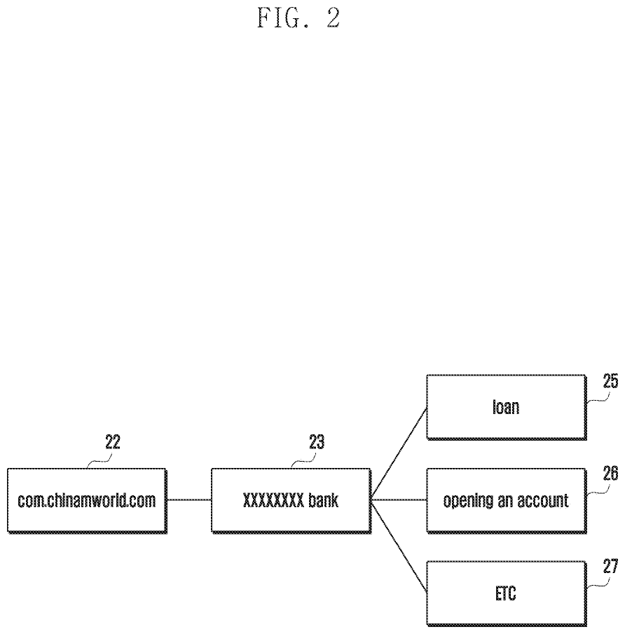

FIG. 2 illustrates an example of a mapping relationship between an application and services of its issuer according to an embodiment of the disclosure.

Referring to FIG. 2, in the database, a mapping relationship between the package name “com.chinamworld.com” 22 of an application and the issuer “XXXX Bank” 23 of the application may be established, and mapping relationships between the issuer “XXXX Bank” 23 and its services “loan” 25, “opening an account” 26 and “ETC (Electronic Toll Collection)” 27 are established. Accordingly, the service of the issuer of the application may be determined through the database based on the acquired identification information of the application.

As another example, the purpose of the to-be-sent resource may be identified according to the content currently displayed in a user interface for sending the to-be-sent resource and/or the context content not currently displayed in the user interface (e.g., earlier context content, etc.). As an example, the purpose of the to-be-sent resource may be identified by semantically processing text in the content currently displayed in the user interface and/or the context content not currently displayed and/or text in an image. For example, layout information of the user interface for sending the to-be-sent resource is acquired, then character string information (for example, control information, etc.) of the user interface is acquired from the layout information, and the acquired character string information is semantically processed to identify the purpose of the to-be-sent resource. Alternatively, the part currently displayed in the user interface for sending the to-be-sent resource may be acquired by screenshot, then the content of the shot image is identified using an image recognition technology (for example, OCR (Optical Character Recognition) technology), and the purpose of the to-be-sent resource is identified based on the identified content. For example, when the content currently displayed in the user interface for sending the to-be-sent resource includes a keyword “car selling”, the purpose of the to-be-sent resource may be determined as handling a car trading service.

As another example, the purpose of the to-be-sent resource may be identified according to identification information of an application for sending the to-be-sent resource. For example, the purpose of the to-be-sent resource may be identified according to the name of an application, for example, if the name of the application is “Straight Flush Stock” or “Guangfa Securities Easy Gold”, etc., the purpose of the to-be-sent resource may be determined as handling a securities trading service, or handling a securities account opening service”, etc.

As another example, the purpose of the to-be-sent resource may be identified according to the attribute information of an object for receiving the to-be-sent resource and/or the content of a historical communication record with the object. For example, the object for receiving the to-be-sent resource may include at least one of the following: a contact (for example, a contact in an address book corresponding to each application, e.g., a contact in an address book corresponding to a phone application and/or a short message application, a contact in an address book corresponding to the WeChat application, etc.), a website, an official account (for example, WeChat Official Account), and a platform. As an example, the attribute information of the object for receiving the to-be-sent resource may include at least one of the following: a name, a remark, a label, a job, and an address. As an example, the stored attribute information of the object for receiving the to-be-sent resource may be acquired from an electronic terminal, and the attribute information of the object for receiving the to-be-sent resource may also be acquired by other ways, for example, the attribute information of the object is queried on line according to the phone number of the object for receiving the to-be-sent resource.

FIGS. 3, 4, and 5 illustrate an example of identifying a purpose of a to-be-sent resource according to various embodiments of the disclosure.

Referring to FIG. 3, the purpose of the to-be-sent resource may be determined as handling a house purchase service based on the name “Real Estate Agency” of the object for receiving the to-be-sent resource.

Referring to FIG. 4, the purpose of the to-be-sent resource may be determined as handling a car purchase service based on the label “Car Sales” of the object for receiving the to-be-sent resource.

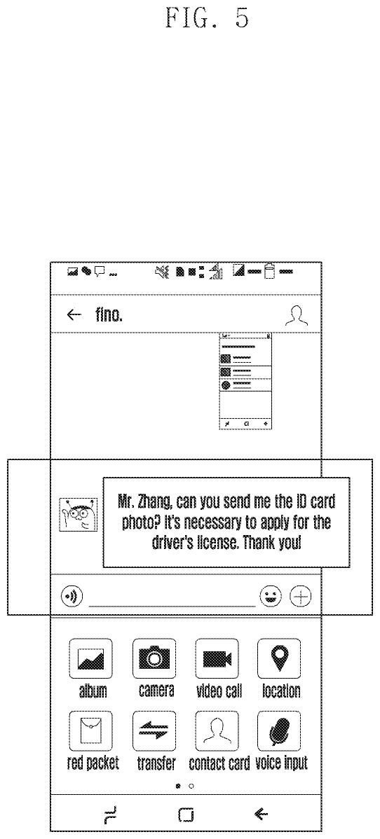

Referring to FIG. 5, by semantically analyzing the content of a historical communication record with the object, it is determined that the user may need to upload an ID image to handle a driver's license, and accordingly, the purpose of the to-be-sent resource may be determined as handling a driver's license service.

It should be understood that the above embodiments may be combined appropriately to identify the purpose of the to-be-sent resource.

As another example, a content of a watermark added to a resource sent by other electronic terminal or the current electronic terminal for the same sending scenario and/or the same receiving object may be acquired; and the purpose of the to-be-sent resource is identified based on the acquired content. Here, as an example, at least one kind of attribute information of the sent resource and the to-be-sent resource may be the same, for example, the labels of the two are the same, and both of them are “ID card”.

As an example, the sending scenario may be determined as the same when one of the following conditions is satisfied: the issuers of applications for sending the to-be-sent resource are the same or similar, the identification information of the applications for sending the to-be-sent resource is the same or similar, the services of the issuers of the applications for sending the to-be-sent resource are the same or similar, and the contents displayed by user interfaces for sending the to-be-sent resource are the same or similar.

As an example, the receiving object may be determined the same when one of the following conditions is satisfied: the attribute information of objects for receiving the to-be-sent resource is the same or similar, and the contents of historical communication records with the objects for receiving the to-be-sent resource are the same or similar.

For example, the content of a watermark added to a resource sent by other electronic terminal through the same or similar user interface as the user interface currently used for sending the to-be-sent resource may be acquired. Alternatively, the content of a watermark added to a resource sent by other electronic terminal to a website or an official account for receiving the to-be-sent resource may be acquired.

In operation S30, a watermark added to the to-be-sent resource is recommended based on the identified purpose.

As an example, the recommended watermark may be used to define that the purpose of the to-be-sent resource is only for identification. For example, the recommended watermark may be: a watermark whose content is “copy of this ID card is only for handling a residence migration service”, or a watermark whose content is “this copy is only for handling a provident fund loan service, invalid for other purposes”, etc.

As another example, the recommended watermark may be used to indicate that the to-be-sent resource is only for a to be used scenario.

As another example, the recommended watermark may be used to indicate the ownership of copyright of the to-be-sent resource.

As another example, the recommended watermark may be a digital signature.

In addition, as an example, a watermark added to the to-be-sent resource may be recommended based on the type of the to-be-sent resource, for example, when the type of the to-be-sent resource is a privacy image, a watermark whose content is “the ownership of copyright of the photo is xxx”, or a digital signature, etc. may be recommended.

Moreover, as an example, the method for recommending a watermark for an electronic terminal according to an embodiment of the disclosure may further include: acquiring and recommending a watermark added in a historical record of the added watermark in the to-be-sent resource. In other words, the added watermark used to be added to the to-be-sent resource is acquired as a watermark candidate for the user to select.

Further, as an example, the method for recommending a watermark for an electronic terminal according to an embodiment of the disclosure may further include: recommending a watermark added to the to-be-sent resource according to user's habit of adding a watermark. For example, the user's habit of adding a watermark may include the watermark the user often adds for a certain type of resources.

Further, as an example, the method for recommending a watermark for an electronic terminal according to an embodiment of the disclosure may further include: sending a resource added with the recommended watermark.

As an example, a resource added with a watermark selected by a user from at least one recommended watermark is sent.

As an example, in operation S30, a plurality of watermarks respectively used for defining different purposes of the to-be-sent resource may be recommended based on the plurality of purposes identified in operation S20, and then a resource added with a watermark selected by the user from the plurality of recommended watermarks is sent. For example, as shown in FIG. 2, when it is determined that the purpose of the to-be-sent resource is one of handling a loan service, an account opening service and an ETC service, a watermark candidate whose content is “this copy only for handling a loan service”, a watermark candidate whose content is “this copy only for handling an account opening service”, and a watermark candidate whose content is “this copy only for handling an ETC service” may be recommended to the user, so that among which, the user selects a required watermark candidate.

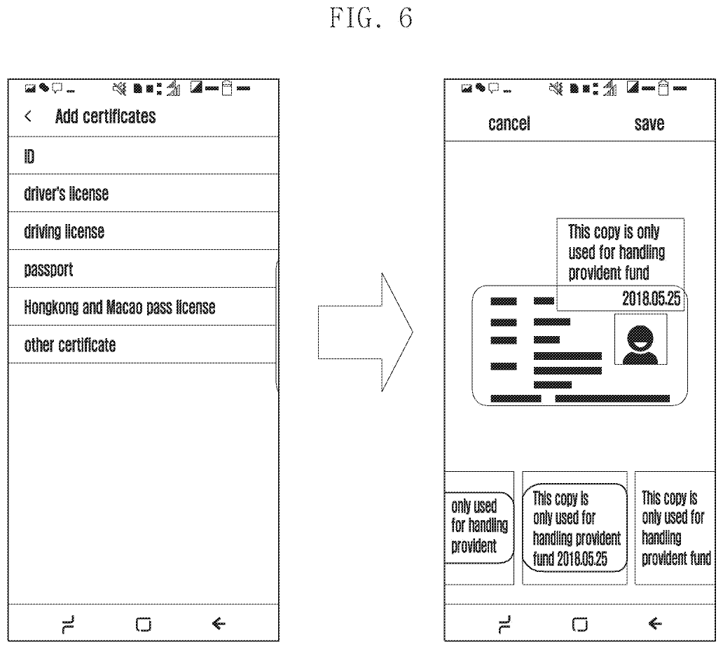

FIG. 6 illustrates an example of a recommended watermark according to an embodiment of the disclosure.

Referring to FIG. 6, a label of a certificate image may be directly acquired when the certificate image is saved, so that when the image needs to be sent, the purpose of the image may be identified based on the type of the image, at least one watermark candidate is recommended to the user, a watermark candidate selected by the user from the provided watermark candidates is added to the image, and the image with the selected watermark is sent.

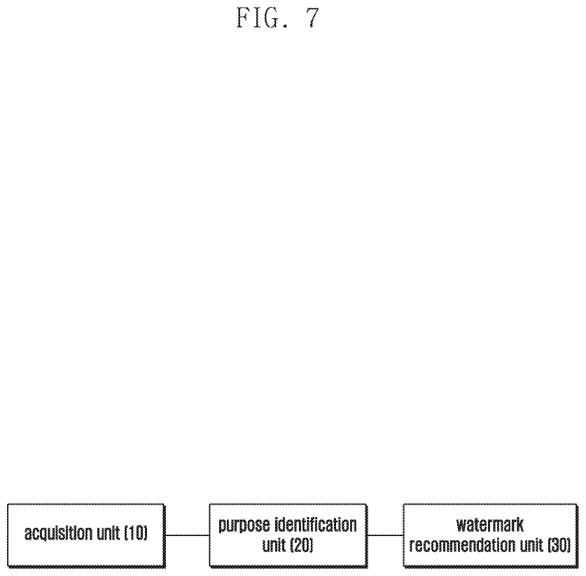

FIG. 7 illustrates a block diagram of a device for recommending a watermark for an electronic terminal according to an embodiment of the disclosure.

Referring to FIG. 7, the device for recommending a watermark for an electronic terminal according to an embodiment of the disclosure includes an acquisition unit 10, a purpose identification unit 20, and a watermark recommendation unit 30.

Specifically, the acquisition unit 10 is configured for acquiring a to-be-sent resource. As an example, the to-be-sent resource may be a video, an image, a design file, a document, etc.

As an example, the acquisition unit 10 may acquire the to-be-sent resource from an album application, or acquire the to-be-sent resource by calling a camera application for shooting. It should be understood that the acquisition unit 10 can also acquire the to-be-sent resource by other suitable ways.

As an example, the acquisition unit 10 may acquire the to-be-sent resource when receiving a user operation for sending a resource. As an example, the user operation for sending a resource may be various types of user operations, for example, a user operation of uploading a resource through an application (e.g., uploading a resource to a website, a platform, an official account, etc.), or a user operation of sharing a resource to other users through an instant messaging application.

As an example, the acquisition unit 10 may acquire a preset type of to-be-sent resource.

As an example, the preset type may include: a privacy resource and/or a preset type of certificate image. As an example, the certificate image may be obtained by shooting or scanning a certificate. In addition, the certificate image may also include a shot image of a user holding a certificate.

As an example, the privacy resource may include at least one of the following: a certificate photo (i.e., a photo that can be used on a certificate to prove identity), a shot user video, a design file, and a document. For example, the user video may include a shot video of user holding a certificate (e.g., an ID card), a shot video of a user performing a specified action, and a shot video of a user reading a specified character. For example, the document may include a contract, an agreement, etc.

As an example, the preset type may include all of or part of certificate image types. For example, the preset type may include at least one of the following: an ID card image, a driver's license image, a driving license image, a passport image, a Hong Kong and Macao pass license image, a student ID image, a residence booklet image, a property certificate image, a contract image, a bank card image, an employee's card image, and a certificate image. For example, if the preset type includes all types of certificate images, as long as one image is a certificate image, regardless of which specific type of certificate image the image is, the image is a certificate image of the preset type. As an example, a user may set the preset type according to his/her needs.

The acquisition unit 10 may identify the type of to-be-sent resource in various suitable ways. As an example, the type of the to-be-sent resource may be determined based on at least one of the following: a label of the to-be-sent resource, a remark of the to-be-sent resource, a name of the to-be-sent resource, and a content of the to-be-sent resource. For example, if the label of the to-be-sent image is an ID card, the acquisition unit 10 may determine that the type of the to-be-sent image is an ID card image. As an example, in response to a user's operation of labelling an image in an album application, a corresponding label may be added to the image. For example, when the image is saved in the album application, the user may be prompted to add a corresponding label to the image.

The purpose identification unit 20 is configured for identifying a purpose of the to-be-sent resource.

As an example, the purpose of the to-be-sent resource may be a scenario to be used after the resource is sent to a receiver (i.e., an object for receiving the resource). For example, the scenario to be used may be a scenario for handling a service, for example, a scenario for handling a residence migration service, a scenario for handling a provident fund loan service, a scenario for handling a driver's license service, a scenario for handling a car purchase service, etc.

The purpose identification unit 20 may identify the purpose of the to-be-sent resource in various suitable ways. As an example, the purpose identification unit 20 may identify the purpose of the to-be-sent resource according to at least one of a sending scenario of the to-be-sent resource, information of a receiving object of the to-be-sent resource, and attribute information of the to-be-sent resource.

As an example, the sending scenario may include at least one of the following: an issuer of an application for sending the to-be-sent resource, a service of the issuer, identification information of the application, a current display content in a user interface for sending the to-be-sent resource, and a context content not currently displayed in the user interface.

As an example, the information of the receiving object may include at least one of the following: attribute information of the object for receiving the to-be-sent resource, and a content of a historical communication record with the object.

As an example, the attribute information of the to-be-sent resource may include at least one of the following: a label of the to-be-sent resource, a remark of the to-be-sent resource, a name of the to-be-sent resource, and a content of the to-be-sent resource.

As an example, the purpose identification unit 20 may determine the purpose of the to-be-sent resource by the service handled by an issuer of an application for sending the to-be-sent resource. As an example, the purpose identification unit 20 may first acquire identification information (e.g., name, package name, etc.) of the application for sending the to-be-sent resource, and then determine the service of the issuer of the application based on the acquired identification information. As an example, when an image is sent through an application, an album application needs to be enabled to select the to-be-sent image therein (for example, as shown in FIGS. 3 and 4, an album application is enabled in response to a user's operation of clicking a control for adding an image). In this case, the purpose identification unit 20 may acquire a package name of the application for sending the image by acquiring a package name of an application for enabling the album application, or acquire a package name of the application for sending the image based on application stack information, for example, acquire identification information of a previous application of the album application among the applications running in the background based on application stack information. As an example, the purpose identification unit 20 may pre-establish a database in which the identification information of each application may be associatively stored with its issuer, and each issuer may be associatively stored with its services; or the identification information of each application may be directly associatively stored with services of its issuer. Accordingly, the purpose identification unit 20 may determine the service of the issuer of the application through the database based on the acquired identification information of the application.

As another example, the purpose identification unit 20 may identify the purpose of the to-be-sent resource according to the content currently displayed in a user interface for sending the to-be-sent resource and/or the context content not currently displayed in the user interface (e.g., earlier context content, etc.). As an example, the purpose identification unit 20 may identify the purpose of the to-be-sent resource by semantically processing text in the content currently displayed in the user interface and/or the context content not currently displayed and/or text in an image. For example, the purpose identification unit 20 may acquire layout information of the user interface for sending the to-be-sent resource, then acquire character string information (for example, control information, etc.) of the user interface from the layout information, and semantically process the acquired character string information to identify the purpose of the to-be-sent resource. Alternatively, the purpose identification unit 20 may acquire, by screenshot, the part currently displayed in the user interface for sending the to-be-sent resource, then identify the content of the shot image by using an image recognition technology (for example, OCR (Optical Character Recognition) technology), and identify the purpose of the to-be-sent resource based on the identified content. For example, when the content currently displayed in the user interface for sending the to-be-sent resource includes a keyword “car selling”, the purpose of the to-be-sent resource may be determined as handling a car trading service.

As another example, the purpose identification unit 20 may identify the purpose of the to-be-sent resource according to identification information of an application for sending the to-be-sent resource. For example, the purpose of the to-be-sent resource may be identified according to the name of an application, for example, if the name of the application is “Straight Flush Stock” or “Guangfa Securities Easy Gold”, etc., the purpose of the to-be-sent resource may be determined as handling a securities trading service, or handling a securities account opening service”, etc.

As another example, the purpose identification unit 20 may identify the purpose of the to-be-sent resource according to the attribute information of an object for receiving the to-be-sent resource and/or the content of a historical communication record with the object. For example, the object for receiving the to-be-sent resource may include at least one of the following: a contact (for example, a contact in an address book corresponding to each application, e.g., a contact in an address book corresponding to a phone application and/or a short message application, a contact in an address book corresponding to the WeChat application, etc.), a website, an official account (for example, WeChat Official Account), and a platform. As an example, the attribute information of the object for receiving the to-be-sent resource may include at least one of the following: a name, a remark, a label, a job, and an address. As an example, the stored attribute information of the object for receiving the to-be-sent resource may be acquired from an electronic terminal, and the attribute information of the object for receiving the to-be-sent resource may also be acquired by other ways, for example, the attribute information of the object is queried on line according to the phone number of the object for receiving the to-be-sent resource.

It should be understood that the above embodiments may be combined appropriately to identify the purpose of the to-be-sent resource.

As another example, the purpose identification unit 20 may acquire a content of a watermark added to a resource sent by other electronic terminal or the current electronic terminal for the same sending scenario and/or the same receiving object; and identify the purpose of the to-be-sent resource based on the acquired content. Here, as an example, at least one kind of attribute information of the sent resource and the to-be-sent resource may be the same, for example, the labels of the two are the same, and both of them are “ID card”.

As an example, the purpose identification unit 20 may determine the sending scenario as the same when one of the following conditions is satisfied: the issuers of applications for sending the to-be-sent resource are the same or similar, the identification information of the applications for sending the to-be-sent resource is the same or similar, the services of the issuers of the applications for sending the to-be-sent resource are the same or similar, and the contents displayed by user interfaces for sending the to-be-sent resource are the same or similar.

As an example, the purpose identification unit 20 may determine the receiving object as the same when one of the following conditions is satisfied: the attribute information of objects for receiving the to-be-sent resource is the same or similar, and the contents of historical communication records with the objects for receiving the to-be-sent resource are the same or similar.

For example, the purpose identification unit 20 may acquire the content of a watermark added to a resource sent by other electronic terminal through the same or similar user interface as the user interface currently used for sending the to-be-sent resource. Alternatively, the content of a watermark added to a resource sent by other electronic terminal to a website or an official account for receiving the to-be-sent resource may be acquired.

The watermark recommendation unit 30 is configured for recommending a watermark added to the to-be-sent resource based on the identified purpose.

As an example, the recommended watermark may be used to define that the purpose of the to-be-sent resource is only for identification. For example, the recommended watermark may be: a watermark whose content is “copy of this ID card is only for handling a residence migration service”, or a watermark whose content is “this copy is only for handling a provident fund loan service, invalid for other purposes”, etc.

As another example, the recommended watermark may be used to indicate that the to-be-sent resource is only for a to be used scenario.

As another example, the recommended watermark may be used to indicate the ownership of copyright of the to-be-sent resource.

As another example, the recommended watermark may be a digital signature.

In addition, as an example, the watermark recommendation unit 30 may recommend a watermark added to the to-be-sent resource based on the type of the to-be-sent resource, for example, when the type of the to-be-sent resource is a privacy image, the watermark recommendation unit 30 may recommend a watermark whose content is “the ownership of copyright of the photo is xxx”, or a digital signature, etc.

Further, as an example, the watermark recommendation unit 30 may also acquire and recommend a watermark added in a historical record of the added watermark in the to-be-sent resource. In other words, the watermark recommendation unit 30 acquires the added watermark used to be added to the to-be-sent resource as a watermark candidate for the user to select.

In addition, as an example, the watermark recommendation unit 30 may also recommend a watermark added to the to-be-sent resource according to user's habit of adding a watermark. For example, the user's habit of adding a watermark may include the watermark the user often adds for a certain type of resources.

Further, as an example, the device for recommending a watermark for an electronic terminal according to an embodiment of the disclosure may further include: a sending unit (not shown), configured for sending a resource added with the recommended watermark.

As an example, the sending unit sends a resource added with a watermark selected by a user from at least one recommended watermark.

As an example, the watermark recommendation unit 30 may recommend a plurality of watermarks respectively used for defining different purposes of the to-be-sent resource based on the plurality of purposes identified by the purpose identification unit 20, and then the sending unit sends a resource added with a watermark selected by the user from the plurality of recommended watermarks.

Moreover, it should be appreciated that various units in the device for recommending a watermark for an electronic terminal according to the embodiments of the disclosure may be implemented as hardware components and/or software components. Those skilled in the art may implement the various units, for example, using a Field Programmable Gate Array (FPGA) or an Application Specific Integrated Circuit (ASIC), depending on the processing performed by the various defined units.

A computer readable storage medium according to an embodiment of the disclosure stores a computer program that, when executed by a processor, causes the processor to execute the method for recommending a watermark for an electronic terminal according to the above embodiments. The computer readable storage medium is any data storage apparatus that can store data read by a computer system. Examples of the computer readable storage medium include a read-only memory, a random-access memory, a read-only optical disk, a magnetic tape, a floppy disk, an optical data storage apparatus, and a carrier (such as data transmission over the Internet via a wired or wireless transmission path).

An electronic terminal according to an embodiment of the disclosure includes a processor (not shown) and a memory (not shown), where the memory stores a computer program, and when the computer program is executed by the processor, the method for recommending a watermark for an electronic terminal according to the above embodiments is implemented.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for recommending a watermark for an electronic terminal, the method comprising:
acquiring a to-be-sent resource;
identifying a purpose of the to-be-sent resource; and
recommending, based on the identified purpose, a watermark to be added to the to-be-sent resource.

2. The method according to claim 1, wherein at least one of:
the acquiring of the to-be-sent resource includes acquiring a preset type of to-be-sent resource;
the identifying of the purpose of the to-be-sent resource includes identifying the purpose of the to-be-sent resource according to at least one of a sending scenario of the to-be-sent resource, information of a receiving object of the to-be-sent resource, or attribute information of the to-be-sent resource,
the recommended watermark is used to define that the to-be-sent resource is only used for identified purpose;
the recommended watermark is used to indicate the ownership of copyright of the to-be-sent resource;
the recommended watermark is a digital signature; or
the method further comprises sending a resource added with the recommended watermark.

3. The method according to claim 2, wherein at least one of:
the sending scenario comprises at least one of: an issuer of an application for sending the to-be-sent resource, a service of the issuer, identification information of the application, a current display content in a user interface for sending the to-be-sent resource, or a context content not currently displayed in the user interface;
the information of the receiving object comprises at least one of attribute information of the object for receiving the to-be-sent resource, or a content of a historical communication record with the object;
the attribute information of the to-be-sent resource comprises at least one of a label of the to-be-sent resource, a remark of the to-be-sent resource, a name of the to-be-sent resource, or a content of the to-be-sent resource, or
the preset type includes at least one of a privacy resource or a preset type of certificate image.

4. The method according to claim 3, wherein the object for receiving the to-be-sent resource comprises at least one of a contact, a website, an official account, or a platform.

5. The method according to claim 2, wherein the sending of the resource added with the recommended watermark comprises sending a resource added with a watermark selected by a user from the recommended watermarks.

6. The method according to claim 5, wherein at least one of:
the recommending, based on the identified purpose, a watermark added to the to-be-sent resource comprises recommending a plurality of watermarks respectively used for defining different purposes of the to-be-sent resource based on a plurality of identified purposes,
the method further comprises acquiring and recommending a watermark added in a historical record of the added watermark in the to-be-sent resource, or
the method further comprises recommending a watermark added to the to-be-sent resource according to a user's habit of adding a watermark.

7. The method according to claim 2, wherein the identifying of the purpose of the to-be-sent resource comprises:
acquiring a content of a watermark added to a resource sent by another electronic terminal for the same sending scenario and/or the same receiving object; and
identifying the purpose of the to-be-sent resource based on the acquired content.

8. A device for recommending a watermark for an electronic terminal, the device comprising:
at least one processor including an acquisition unit, a purpose identification unit and a watermark recommendation unit,
wherein the acquisition unit is configured to acquire a to-be-sent resource,
wherein the purpose identification unit is configured to identify a purpose of the to-be-sent resource, and
wherein the watermark recommendation unit is configured to recommend, based on the identified purpose, a watermark to be added to the to-be-sent resource.

9. The device according to claim 8, wherein at least one of:
the acquisition unit is further configured to acquire a preset type of to-be-sent resource;
the purpose identification unit is further configured to identify the purpose of the to-be-sent resource according to at least one of a sending scenario of the to-be-sent resource, information of a receiving object of the to-be-sent resource, or attribute information of the to-be-sent resource;
the recommended watermark is further configured to define that the to-be-sent resource is only used for identified purpose;
the recommended watermark is further configured to indicate the ownership of copyright of the to-be-sent resource;
the recommended watermark includes a digital signature; or
the at least one processor further includes a sending unit configured to send a resource added with the recommended watermark.

10. The device according to claim 9, wherein at least one of:
the sending scenario includes at least one of an issuer of an application for sending the to-be-sent resource, a service of the issuer, identification information of the application, a current display content in a user interface for sending the to-be-sent resource, or a context content not currently displayed in the user interface;
the information of the receiving object includes at least one of attribute information of the object for receiving the to-be-sent resource, or a content of a historical communication record with the object;
the attribute information of the to-be-sent resource includes at least one of a label of the to-be-sent resource, a remark of the to-be-sent resource, a name of the to-be-sent resource, or a content of the to-be-sent resource; or
the preset type includes at least one of a privacy resource or a preset type of certificate image.

11. The device according to claim 10, wherein, the object for receiving the to-be-sent resource includes at least one of a contact, a website, an official account, or a platform.

12. The device according to claim 9, wherein, the sending unit is further configured to send a resource added with a watermark selected by a user from the recommended watermarks.

13. The device according to claim 12, wherein at least one of:
the watermark recommendation unit is further configured to recommend a plurality of watermarks respectively used for defining different purposes of the to-be-sent resource based on a plurality of identified purposes; the watermark recommendation unit is further configured to acquire and recommend a watermark added in a historical record of the added watermark in the to-be-sent resource; or
the watermark recommendation unit is further configured to recommend a watermark added to the to-be-sent resource according to a user's habit of adding a watermark.

14. The device according to claim 9, wherein, the purpose identification unit is further configured to:
acquire a content of a watermark added to a resource sent by another electronic terminal for the same sending scenario and/or the same receiving object; and
identify the purpose of the to-be-sent resource based on the acquired content.

15. A computer readable storage medium storing a computer program, wherein, when the computer program is executed by a processor, the method for recommending a watermark for an electronic terminal according to claim 1 is implemented.

16. An electronic terminal, comprising
at least one processor; and
a memory for storing a computer program,
wherein, when the computer program is executed by the at least one processor, the method for recommending a watermark for an electronic terminal according to claim 1 is implemented.
